(19) United States
(12) Patent Application Publication
(10) Pub. No.: US 2010/0050804 A1
(43) Pub. Date: Mar. 4, 2010

(54) Shift lever assembly and assembling method of shift lever assembly

(75) Inventor: Yoshihiro Takikawa, Toyokawa-shi (JP)

Correspondence Address: THE NATH LAW GROUP, 112 South West Street, Alexandria, VA, 22314, US

(73) Assignee: FUJI KIKO CO., Ltd., Kosai-shi (JP)

(21) Appl. No.: 12/461,099

(22) Filed: Jul. 31, 2009

(30) Foreign Application Priority Data
Aug. 29, 2008 (JP) P2008-222367

(51) Int. Cl. G05G 5/06; B23P 11/00

(52) U.S. Cl. 74/473.23; 29/428

(57) ABSTRACT

A shift lever assembly includes a shift lever for shifting a gear position of a transmission, an operated member housed within the shift lever slidably along a longitudinal direction, a shift knob provided at a top of the shift lever for being held by a driver, a knob button coupled with the shift knob for shifting the operated member according to an operation thereof and pivotally supported between a temporarily-held position and an operative position, a cam plate integrally formed on an inside of the knob button, a cam pin provided on the operated member and cooperative with the cam plate, and a boss for holding the knob button at the temporarily-held position by contacting with the cam plate while assembling. The shift lever assembly can have a relatively simple structure and can decrease the number of components. In addition, the shift lever assembly can also improve assembling workability.

### BACKGROUND OF THE INVENTION

1. Field of the Invention

The present invention relates to a pull-up type shift lever assembly, which release locking of a detent through an operation of a knob button provided in a shift knob for pulling-up a compression rod, and an assembling method of the shift lever assembly.

2. Description of Related Art

A conventional pull-up type shift lever (selector lever) assembly is disclosed in Japanese Patent Application Laid-open No. 2005-1470 (Patent Document 1). As shown in FIGS. 8 and 9, the conventional shift lever assembly 100 includes a cylindrical shift lever 101 provided swingably in a front-back direction of a vehicle (horizontal direction in FIG. 8), a shift knob 102 coupled on the top of the shift lever 101, and an operated member 103 housed in the shift lever 101 and the shift knob 102. A detent 105 is provided at a bottom of a base 104 of the shift lever 101 for holding a position of the shift lever 101. The detent 105 holds the position of the shift lever 101 by being latched with a detent plate 107 provided at a support member (vehicle body) 106 and releases the hold of the position of the shift lever 101 by being unlatched with the detent plate 107. A knob button 108 is provided at a front side (left side in FIG. 8) of the shift knob 102 and the knob button 108 is to be pressed on operating the shift lever 101. A link member 109 to be interlocked with the knob button 108 is provided on the inside of the knob button 108. A curved plunger 110 is projected from one end of the link member 109 along a pressing direction of the knob button 108. A pivot axis 111 is provided at the other end of the link member 109 and a pin 112 is provided at the midpoint of the link member 109. The pin 112 is inserted into an elongated hole 113 of the knob button 108.

The operated member 103 consists with a compression rod 114 reciprocatably housed in the shift lever 101 and a pull block 116 coupled with the compression rod 114 with a connecting rod 115 being interposed therebetween. The above-mentioned detent 105 is provided at a bottom of the compression rod 115. The compression rod 114 is urged downward by a compressed spring 117 interposed between an upper end of the shift lever 101 and an upper end of the compression rod 114. Therefore, the detent 105 is latched with the detent plate 107. The pull block 116 has a coupled hole 118 that is to be coupled with the curved plunger 110.

In the above-described configuration, the knob button 108 and the link member 109 are pre-assembled with the shift knob 102 and the operated member is pre-assembled with the shift lever 101. And then, the pre-assembled shift knob 102 is coupled with the pre-assembled shift lever 101 from above. At this time, the curved plunger 110 of the link member 109 is inserted into the coupled hole 118 of the pull block 116 to interlock the link member 109 and the operated member 103. The shift lever assembly is assembled as described above. The pull block 116 is pulled up by the link member 109 and the operated member 103 that are interlocked each other when a driver holds the shift knob 102 and press the knob button 108. According to the above-described movement, the connecting rod 115 and the compression rod 114 are also pulled up against spring force of the compressed spring 117 to unlatch the detent 105 and the detent plate 107. As a result, the shift lever 101 is made operable. From this state, the driver can operate the shift lever 101 along the front-back direction to change the position of the shift lever 101 and thereby a gearshift control of a transmission 109 is done according to the position of the shift lever 101.

### SUMMARY OF THE INVENTION

In the assembly disclosed in the Patent Document 1, the operated member 103 is pulled up due to pivotal movement of the link member 109 along with the pressing operation of the knob button 108. It causes a relatively complicated structure and increases the number of components and thereby it causes high production cost. In addition, rattles of the components tend to increase and thereby it is concerned that its operation feeling becomes worse. Furthermore, the curved plunger 110 and the coupled hole 108 are not visible on assembling the pre-assembled shift knob 102 with the pre-assembled shift lever 101. Therefore, it is difficult to insert the curved plunger 109 into the coupled hole 108 and thereby its assembling work becomes troublesome.

The present invention has been achieved in order to solve the above problems and an object of the invention is to provide a shift lever assembly that has a relatively simple structure and can decrease the number of components. In addition, the shift lever assembly of the present invention can also improve assembling workability.

A first aspect of the present invention provides a shift lever assembly that includes a shift lever for shifting a gear position of a transmission, an operated member housed within the shift lever slidably along a longitudinal direction, a shift knob provided at a top of the shift lever for being held by a driver, a knob button coupled with the shift knob for shifting the operated member according to an operation thereof and pivotally supported between a temporarily-held position and an operative position, a cam plate integrally formed on an inside of the knob button, a cam pin provided on the operated member and cooperative with the cam plate, and a boss for holding the knob button at the temporarily-held position by contacting with the cam plate while assembling.

According to the first aspect of the present invention, the cam pin of the pull block is moved by the cam plate integrally formed on the knob button, so that the pull block is pulled up to release shift-locking of the shift lever. Compared with a conventional structure with a link member that interlocks with a knob button, structure of the assembly can be made relatively simple and the number of components in the assembly can be reduced. Therefore, production cost can be reduced and operation feeling can be improved because rattles of the components are restrained. In addition, the shift knob can be coupled with the shift lever with the knob button being held temporarily by contacting the cam plate with the boss. And then the knob button is released from the temporarily-held position by being pressed to make the cam plate traversed-over and passed-through the boss. Therefore, assembling can be done easily and thereby assembling workability can be improved.

It is preferable that the cam plate is provided in a pair and the cam plates are located parallel, the cam pin is provided in a pair and the cam pins are cooperative with the cam plates, respectively, the boss holds the knob button at the temporarily-held position by contacting with at least one of the cam plates while assembling, and the assembly further comprises a guide plate that extends toward the knob button from the operated member and is located between the pair of the cam plates.

According to the above configuration, rattling and chattering of the knob button can be prevented and pivotal movement of the cam plates can be achieved smoothly while the knob button is pressed because the cam plates are guided by the guide plate provided between the cam plates.

It is preferable that a spring for urging the knob button so as to contact the cam plate with the cam pin while the knob button is positioned at the operative position.

According to the above configuration, operating force of the knob button can be reduced because the knob button is urged in its pressing direction by the coil spring. In addition, rattling and chattering between the cam plates and the cam pins can be prevented because the cam plates are made constantly contacted with the cam pins by the coil spring.

A second aspect of the present invention provides a method of assembling a shift lever assembly. The shift lever includes a shift lever for shifting a gear position of a transmission, an operated member housed within the shift lever slidably along a longitudinal direction, a shift knob provided at a top of the shift lever for being held by a driver, a knob button coupled with the shift knob for shifting the operated member according to an operation thereof and pivotally supported between a temporarily-held position and an operative position, a cam plate integrally formed on an inside of the knob button, a cam pin provided on the operated member and cooperative with the cam plate, and a boss for holding the knob button at the temporarily-held position by contacting with the cam plate while assembling. The method of assembling a shift lever assembly comprises: installing the knob button onto the shift knob so as to make the knob button held at the temporarily-held position by contacting the cam plate with the cam pin, coupling the shift knob onto the top of the shift lever, and moving the knob button from the temporarily-held position to the operative position by pressing the knob button so as to make the cam plate cooperative with the cam pin.

According to the second aspect of the present invention, the cam pin of the pull block is moved by the cam plate integrally formed on the knob button, so that the pull block is pulled up to release shift-locking of the shift lever in the assembled shift lever assembly. Compared with a conventional structure with a link member that interlocks with a knob button, structure of the assembly can be made relatively simple and the number of components in the assembly can be reduced. Therefore, production cost can be reduced and operation feeling can be improved because rattles of the components are restrained. In addition, the shift knob can be coupled with the shift lever with the knob button being held temporarily by contacting the cam plate with the boss. And then the knob button is released from the temporarily-held position by being pressed to make the cam plate traversed-over and passed-through the boss. Therefore, assembling can be done easily and thereby assembling workability can be improved.

### BRIEF DESCRIPTION OF THE DRAWINGS

FIG. 1 is a perspective view showing a main portion of a shift lever assembly according to an embodiment of the present invention;

FIG. 2 is a perspective view showing the shift lever assembly according to the embodiment of the present invention;

FIG. 3 is a cross-sectional view showing a connecting portion of a pull block and a compression rod in the shift lever assembly according to the embodiment of the present invention;

FIG. 4 is a perspective view showing a knob button and the pull block in the shift lever assembly according to the embodiment of the present invention;

FIG. 5 is a perspective view showing the knob button, a support member and the pull block in the shift lever assembly according to the embodiment of the present invention;

FIG. 6 is a side view showing the shift lever assembly according to the embodiment of the present invention with the knob button being detached from the support member;

FIG. 7 is a side view showing cam movement in the shift lever assembly according to the embodiment of the present invention;

FIG. 8 is a cross-sectional view of a conventional shift lever assembly; and

FIG. 9 is a perspective view showing the conventional shift lever assembly.

### DETAILED DESCRIPTION OF THE EMBODIMENTS

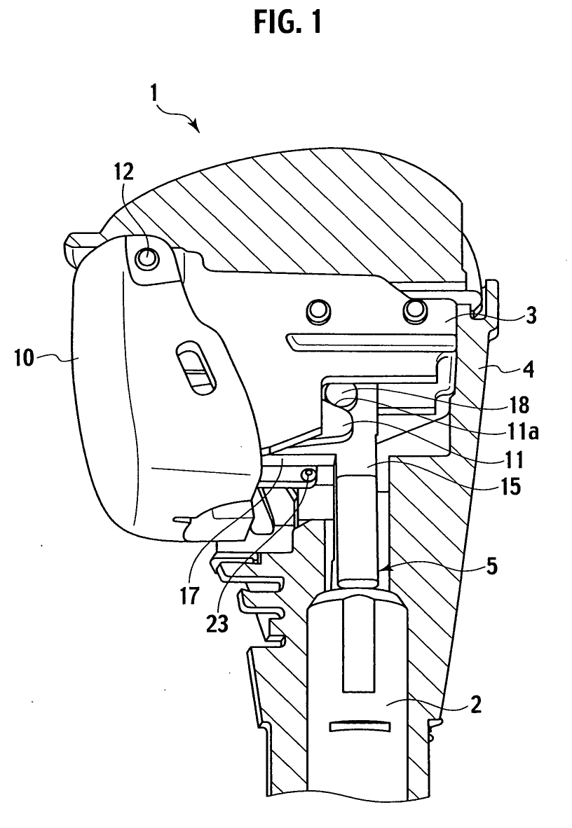

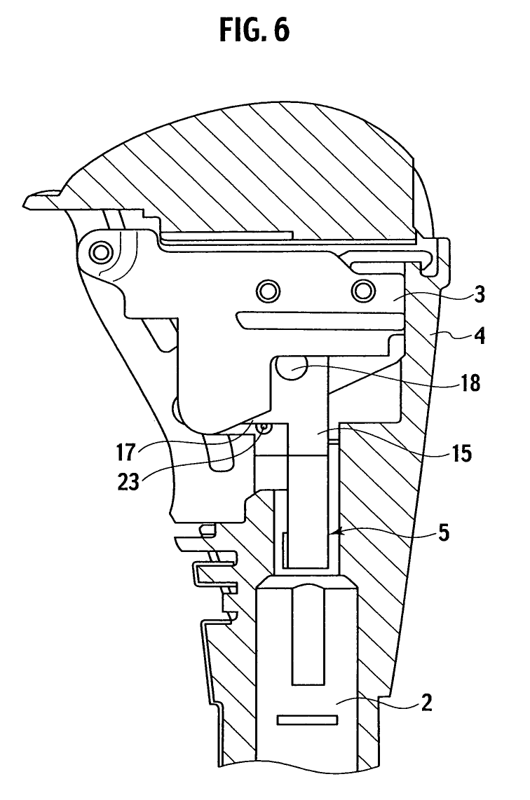

One embodiment of the present invention will be described hereinafter with reference to FIGS. 1 to 7. Note that FIGS. 1 and 6 show a cross-sectioned shift knob for purposes of clear description.

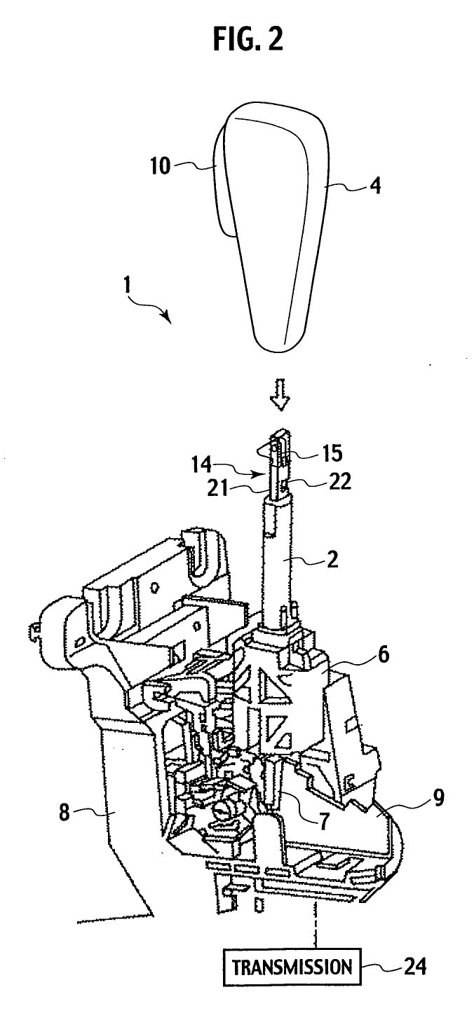

As shown in FIGS. 1 and 2, a shift lever assembly 1 includes a cylindrical shift lever 2 provided swingably in a front-back direction of a vehicle (horizontal direction in FIG. 1), a support member 3 and a shift knob 4 provided on the top (distal end) of the shift lever 2, and an operated member 5 housed in the shift lever 2 and the shift knob 4. As shown in FIG. 2, a shift lever control unit is provided at a bottom of a base 6 of the shift lever 2 for locking a shift-position. The shift lever control unit consists a detent 7 for holding a position of the shift lever 2 and a detent plate 9 provided at a support member (vehicle body) 8. The detent 7 holds the position of the shift lever 2 by being latched with the detent plate 9 and releases the hold of the position of the shift lever 2 by being unlatched with the detent plate 9.

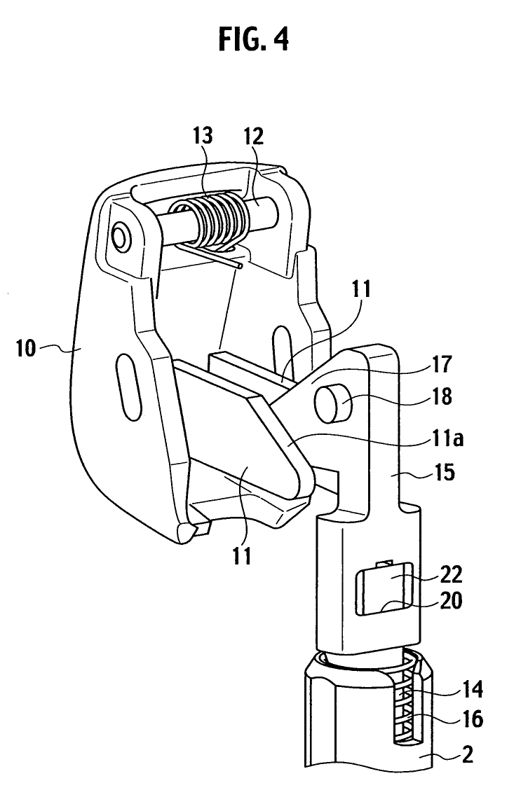

As shown in FIG. 1, the support member 3 is housed in the shift knob 4 and a knob button 10 is provided at a front side (left side in FIG. 1) of the shift knob 4. The knob button 10 is to be pressed on shifting the shift lever 2. As shown in FIG. 4, a pair of cam plates 11 is integrally formed in the inside of the knob button 10.

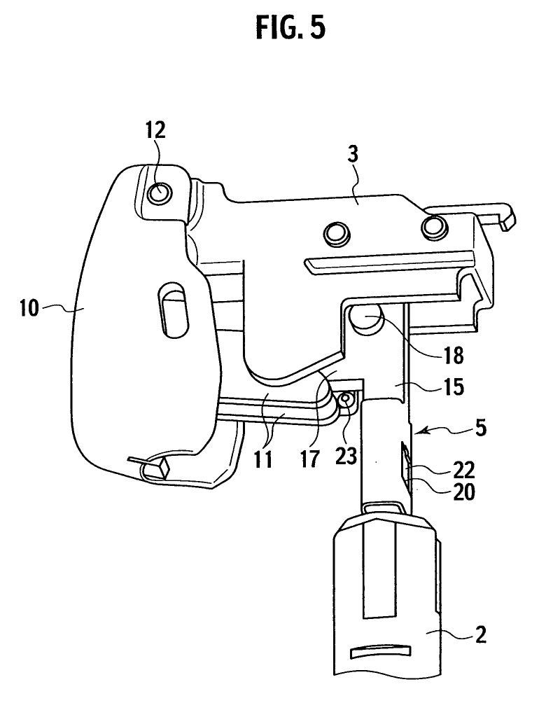

As shown in FIGS. 4 and 5, the knob button 10 is pivotally supported by the support member 3 via a pivot axis shaft 12 and can move pivotally between its temporarily-held position and its operative position. The knob button 10 is urged toward the temporarily-held position by a coil spring 13 wound around the pivot axis shaft 12. The pair of cam plates 11 is provided parallel with a predetermined interval. Each of the cam plates 11 extends along a pressing direction of the knob button 10 and has a cam plane (cam profile) 11a that is gradually sloped down toward its distal end.

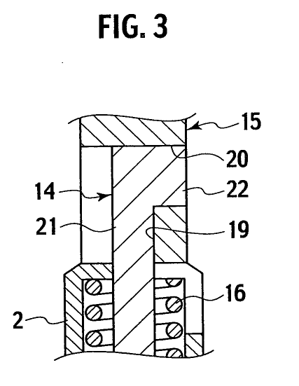

As shown in FIGS. 3 and 4, the operated member 5 consists with a compression rod 14 reciprocatably housed in the shift lever 2 and a pull block 15 connected at a top (distal end) of the compression rod 14. The above-mentioned detent 7 is provided at a bottom of the compression rod 14. The compression rod 14 is urged downward by a compressed spring 16 interposed between an upper end of the shift lever 2 and an upper end of the compression rod 14. Therefore, the detent 7 is latched with the detent plate 9. Note that spring force of the compressed spring 16 is set larger than spring force of the coil spring 13 that urges the knob button 10 in the pressing direction.

As shown in FIG. 4, a guide plate 17 and a pair of cam pins 18 are provided at a top of the pull block 15. The guide plate 17 extends toward the knob button 10 and is interposed between the pair of the cam plates 11. Each of the cam pins 18 is projected from each side face of the pull block 15 along a direction perpendicular to the pressing direction of the knob button 10 and is to be contacted with each of the cam plates 11. As shown in FIG. 3, a joint groove 19 and an opening 20 are provided at a bottom of the pull block 15. The joint groove 19 is formed at a front side (left side in FIG. 3) of the pull block 15 and extends along an axial direction of the pull block 15. The opening 20 is opened at a back side (right side in FIG. 3) of the pull block and communicates with the joint groove 19. A joint axis 21 and a joint pawl 22 are provided at the top of the compression rod 14. The joint axis 21 is coupled with the joint groove 19. The joint pawl 22 extends backward from the joint axis 21 and is engaged with the opening 20.

As shown in FIGS. 5 and 6, a boss 23 is provided at a bottom of the support member 3 and the boss 23 can contact with one of the cam plates 11. The knob button 10 that can pivotally move around the pivot axis shaft 12 is temporarily held in the temporarily-held position when the boss 23 contacts with the one of the cam plates 11 as shown in FIG. 5.

On assembling the shift lever assembly 1 in the present embodiment, the pull block 15 is coupled with the compression rod 14 at the beginning. At this time, the joint axis 21 and the joint pawl 22 on the top of the compression rod 14 are inserted into the joint groove 19 at the bottom of the pull block 15. As a result, joint pawl 22 is engaged with the opening 20 of the pull block 15 as shown in FIG. 3. Next, the knob button 10, the pivot axis shaft 12 and the coil spring 13 are set in the support member 3 and then the knob button 10 is held in the temporarily-held position by making the one of the cam plates 11 contacted with the boss 23 as shown in FIG. 5. Subsequently, the support member 3 with the knob button 10 is installed within the shift knob 4. And then the above-mentioned pre-assembled shift knob 4 is coupled with the shift lever 2 from above. At this time, the pull block 15 is smoothly inserted into the support member 3 because the knob button 10 is temporarily held in the temporarily-held position. While the knob button 10 is temporarily held in the temporarily-held position, the cam plates 11 doesn't interfere the insertion of the cam pins 18. In other words, the cam plates 11 never contact with the cam pins 18 while the shift lever 2 (the pull block 15) is inserted into the shift knob 4.

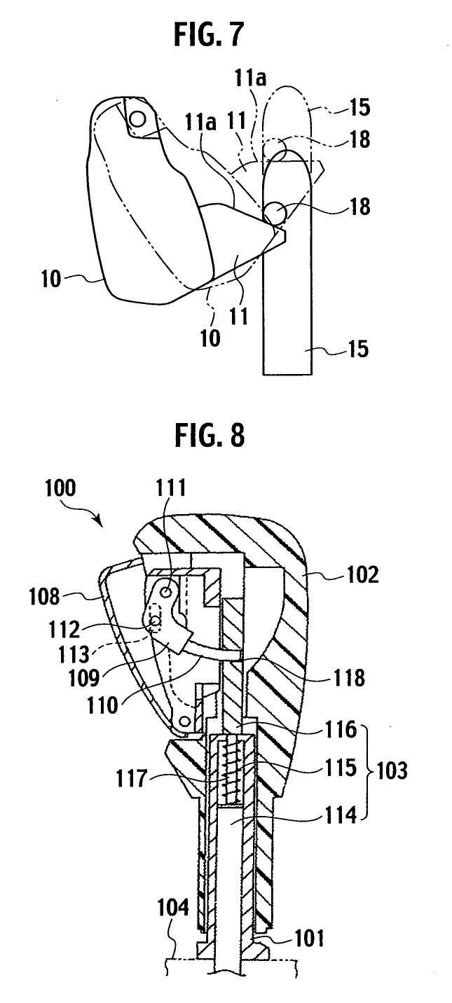

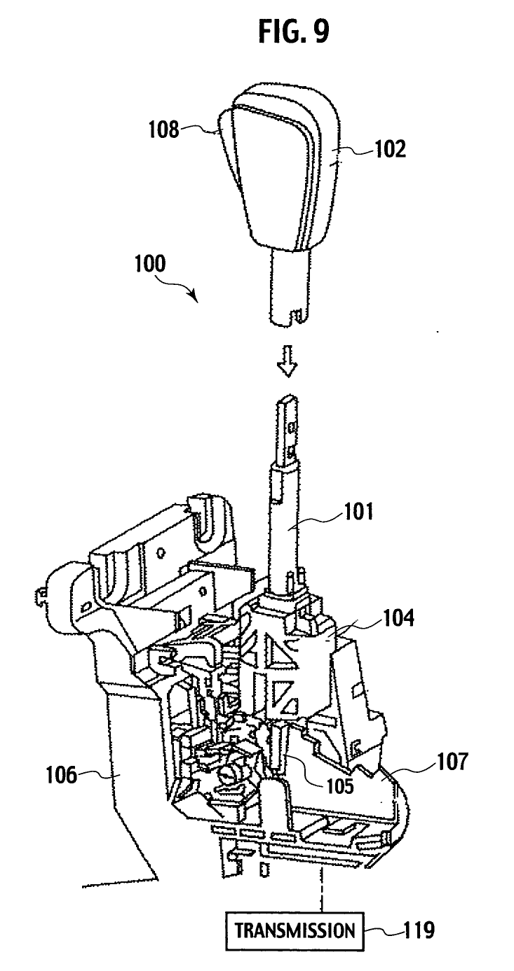

After assembling the shift knob 4 onto the shift lever 2 as described above, the knob button 10 is further pressed to make the cam plate 11 traversed over the boss 23. The knob button 10 is positioned at the operative position after passing through the boss 23 and being released from the contact with the boss 23 and then the cam plates 11 are contacted with the cam pins 18, respectively, by the spring force of the coil spring 13 (see FIG. 1). When a driver holds the shift knob 4 and then presses the knob button 10, the pair of the cam plates 11 pivotally moves along the guide plate 17 positioned between the cam plates 11 as shown in FIG. 7. According to this, the pair of cam pins 18 is moved along the cam planes 11a and thereby the pull block 15 is pulled up. At the same time, the compression rod 14 is also pulled up against the spring force of the compressed spring 16 and thereby the detent 7 is made unlatched from the detent plate 9 to make a gearshift operation enabled. From this state, the position of the shift lever 2 can be shifted due to a driver's operation of the shift lever 2 in the front-back direction and thereby a gearshift control of a transmission 24 is done according to the position of the shift lever 2.

According to the present embodiment as explained above, the cam pins 18 of the pull block 15 are moved by the cam plates 11 integrally formed on the knob button 10, so that the pull block 15 is pulled up to release shift-locking of the shift lever 2. Compared with a conventional structure with a link member that interlocks with a knob button, structure can be made relatively simple and the number of components can be reduced in the present embodiment. Therefore, production cost can be reduced and operation feeling can be improved because rattles of the components are restrained. In addition, the shift knob 4 is coupled with the shift lever 2 with the knob button 10 being held temporarily by contacting the cam plates 11 with the boss 23. And then the knob button 10 is released from the temporarily-held position by being pressed to make the cam plate 11 traversed-over and passed-through the boss 23. Therefore, assembling can be done easily and thereby assembling workability can be improved.

According to the present embodiment, the cam plates 11 are guided by the guide plate 17 provided between the cam plates 11. Therefore, rattling and chattering of the knob button 10 can be prevented and the pivotal movement of the cam plates 11 can be achieved smoothly.

According to the present embodiment, operating force of the knob button 10 can be reduced because the knob button 10 is urged in its pressing direction by the coil spring 13. Therefore, the cam plates 11 are made constantly contacted with the cam pins 18 and thereby rattling and chattering between the cam plates 11 and the cam pins 18 can be prevented.

What is claimed is:

1. A shift lever assembly, comprising:
a shift lever for shifting a gear position of a transmission;
an operated member housed within the shift lever slidably along a longitudinal direction;
a shift knob provided at a top of the shift lever for being held by a driver;
a knob button coupled with the shift knob for shifting the operated member according to an operation thereof and pivotally supported between a temporarily-held position and an operative position;
a cam plate integrally formed on an inside of the knob button;
a cam pin provided on the operated member and cooperative with the cam plate; and
a boss for holding the knob button at the temporarily-held position by contacting with the cam plate while assembling.

2. The shift lever assembly according to claim 1, wherein
the cam plate is provided in a pair and the cam plates are located parallel,
the cam pin is provided in a pair and the cam pins are cooperative with the cam plates, respectively,
the boss holds the knob button at the temporarily-held position by contacting with at least one of the cam plates while assembling, and
the assembly further comprises a guide plate that extends toward the knob button from the operated member and is located between the pair of the cam plates.

3. The shift lever assembly according to claim 1, further comprises
a spring for urging the knob button so as to contact the cam plate with the cam pin while the knob button is positioned at the operative position.

4. A method of assembling a shift lever assembly that includes a shift lever for shifting a gear position of a transmission, an operated member housed within the shift lever slidably along a longitudinal direction, a shift knob provided at a top of the shift lever for being held by a driver, a knob button coupled with the shift knob for shifting the operated member according to an operation thereof and pivotally supported between a temporarily-held position and an operative position, a cam plate integrally formed on an inside of the knob button, a cam pin provided on the operated member and cooperative with the cam plate, and a boss for holding the knob button at the temporarily-held position by contacting with the cam plate while assembling, the method comprising:
installing the knob button onto the shift knob so as to make the knob button held at the temporarily-held position by contacting the cam plate with the cam pin,
coupling the shift knob onto the top of the shift lever, and
moving the knob button from the temporarily-held position to the operative position by pressing the knob button so as to make the cam plate cooperative with the cam pin.
